(19) United States
(12) Patent Application Publication
(10) Pub. No.: US 2015/0079456 A1
(43) Pub. Date: Mar. 19, 2015

(54) BATTERY HAVING A CONNECTING ELEMENT COMPRISED OF PLURAL INDIVIDUAL WIRES

(71) Applicant: AUDI AG, 85045 INGOLSTADT (DE)

(72) Inventor: Thomas Pauleser, Schrobenhausen (DE)

(21) Appl. No.: 14/383,193

(22) PCT Filed: Feb. 14, 2013
(86) PCT No.: PCT/EP2013/000427

§ 371 Date: Sep. 5, 2014

(30) Foreign Application Priority Data
Mar. 6, 2012 (DE) 102012 004 532.8

(51) Int. Cl. H01M 2/20; H01R 43/28; H01R 43/02

(52) U.S. Cl. CPC H01M 2/206; H01R 43/02; H01R 43/28
USPC 429/160; 29/857; 29/868

(57) ABSTRACT

The invention relates to a battery (10), in particular for a vehicle, having at least two battery cells (12) and at least one connecting element (16) that connects at least one electrical pole (14) of a first battery cell (12) to an electrical pole (14) of at least one further battery cell (12). The connecting element (16) includes plural individual wires (18) that are compacted in a respective attachment zone (20). The connecting element (16) is in contact with the respective electrical pole (14) of the battery cell (12) in the respective attachment zone (20). The invention further relates to a method for manufacturing such a battery (10).

The invention relates to a battery with a plurality of battery cells and at least one connecting element which connects an electric pole of a first battery cell with the electric poles of further battery cells. The connecting element includes plural individual wires which are compacted in a respective attachment zone. Furthermore, the invention relates to a method for manufacturing such a battery.

In electric vehicles and hybrid vehicles, electrochemical energy stores in the form of batteries are used to date, which oftentimes are configured as lithium-ion batteries. To realize sufficient output and capacity of the batteries, a plurality of battery cells are connected in series or parallel. The battery may also include a plurality of battery modules in which in turn a plurality of battery cells are arranged and connected in series and/or parallel.

Interconnection or electric connection of the battery cells with one another to form a battery module or a battery system is normally implemented using rigid conductor bars which are made of copper or aluminum. These conductor bars are connected with the respective electric poles of the battery cells by interference fit or material joint so as to establish an electrically conducting connection.

The relative position of the battery cells to one another is subject however to certain fluctuations during manufacture and installation. To compensate these, i.e. to provide a tolerance compensation, constructive measures are applied. This may be necessary in terms of process, for example when the battery cells and the conductor bars must be positioned precisely in relation to one another so as to realize an electric connection by a welding process. Furthermore, measures using a tolerance compensation minimize static mechanical stress such as for example tensile forces upon the electric poles of the battery cells that could otherwise adversely affect the service life of the battery cells or the connection.

U.S. Pat. No. 3,706,955 A describes an electrical cable made form a flat strip of sheet metal. A region between axial ends of the strip of sheet metal is provided with a plurality of slits so that the strip of sheet metal defines in this region a plurality of individual wires. Such a cable can be used for connection to the terminals of a common car battery.

U.S. Pat. No. 5,541,380 A describes a cable having a plurality of individual fibers which are braided. The fibers are solidified in end regions of the cables, e.g. by welding. A first end of the cable can be coupled with a current originating device and a second end with a current receiving device.

DE 27 45 189 A1 describes a current-carrying conductor for connection between the battery and the starter of combustion engines, which conductor is made from a band material. A number of longitudinal slits is provided between a first end, in which the band material is folded to form a lug, and a second end which forms a battery clamp, so that the current-carrying conductor is split into plural individual wires in this region.

It is known in the art, for example from the DE 10 2007 063 177 A1, to use for tolerance compensation a compensating element between a cell connector in the form of a conductor bar and the electric pole, with the compensating element being connected by a material joint with the cell connector on one hand, and with the electric pole on the other hand.

This has the drawback that an additional component is required in the form of the compensating element necessitates. This causes added expense to the production, storage, provision and installation, especially in terms of positioning of the compensating element upon the electric pole and the cell connector. In addition, there is the risk of a short-circuit, for example when the compensating element drops.

The provision of the compensating element increases in addition the weight of the battery. Furthermore, it is disadvantageous that each connection point has two joints, namely between the electric pole and the compensating element on one hand, and between the compensating element and the cell connector on the other hand. Experience has shown that this leads to an increase of the overall electric resistance of the connection.

The provision of compensating elements is able to prevent static loads. However, the rigid connection of the battery cells results in movements of the battery cells in relation to another during operation, directly causing mechanical stress at the electric poles of the battery cells. Such relative movements can be caused in particular by heat expansion but also when subjecting the battery system to bending or torsion in the vehicle.

It is further known, for example from DE 10 2009 058 723 A1 or EP 208 0232 A2, to provide flexible elements within the conductor bar for tolerance compensation. This, however, causes a weakening of the cross section of the conductor bar and thus increased resistances and a reduced current carrying capacity. In the WO 2011 045 088 A1, the provision of flexible elements results within the conductor bar in an increase in length of the conductor bar and thus to an increased weight. Furthermore, the flexibility of such flexible constructions is oftentimes limited to one spatial direction.

It is further known to use a flexible conductor in the form of a litz wire, instead of a rigid conductor bar, for connection of the battery cells. The litz wire is provided with a press-welded sleeve in a region intended for attachment onto the electric pole of the battery cell and then threadably engaged with the battery poles. A drawback hereby is the fact that the pressed sleeves result in added weight and the attachment of the pressed sleeves is very complicated.

WO 2010/142679 A1 describes a battery cell connector in which respective terminal parts of the battery cell connector are made from the same material as the electric poles of the battery cells with which the terminal parts should be connected by a material joint. A connecting part is provided between the terminal parts and is formed from a litz wire or a braid. The litz wire is compacted by brief compaction and heating in the area of attachment of this litz wire to the terminal parts. These compacted regions are connected by a material joint with the respective terminal part.

It has been considered hereby as disadvantageous that the battery cell connector is of relatively complex configuration due to the fact that both the terminal parts and the litz wire have compacted end regions to electrically connect the terminal parts with one another. In addition, the presence of joints between the compacted regions of the litz wire and the terminal parts as well as between the terminal parts and the electric poles of the battery cells can increase the overall resistance of the connection.

Object of the present invention is the provision of both a battery of the afore-mentioned type and a method of manufacturing such a battery to realize a particularly simple structure.

This object is attained by a battery with the features of patent claim 1 and by a method with the features of patent claim 10. Advantageous configurations with appropriate refinements of the invention are set forth in the dependent patent claims.

In the battery according to the invention, the connecting element in the respective attachment zone contacts the respective electric pole of the battery cell. The individual wires are compacted in evenly spaced-apart attachment zones, and the distances of the attachment zones correspond to the distances of the electric poles of the battery cells in the cell assembly of the battery. Due to the compaction of the attachment zones, the latter can be connected directly with the electric pole of the battery cell in an especially good way, just like the case when an attachment zone of an overall rigid conductor bar is involved. Furthermore, the connecting element is especially simple in structure so that the configuration of the entire battery is simplified.

In the afore-described battery, the connecting element provides in addition that the tolerances can be easily compensated in all directions because of the flexibility in its non-compacted regions. Both the attachment zones and the electric poles of the battery cell remain therefore substantially free of mechanical stress during operation of the battery. The high flexibility of the connecting element in its non-compacted regions is based on the plurality of the thin individual wires from which the connecting element is made.

Furthermore, the properties of the compacted attachment zones correspond substantially to those of a solid conductor bar so that the attachment zones allow a simple and reliable attachment of the connecting element—still having a flexibility—onto the respective electric pole of the battery cell. Moreover, a particularly slight transition resistance is encountered in the region of the attachment of the connecting element onto the electric poles because of the compacted attachment zones.

As the respective attachment zones directly contact the respective electric pole of the battery cell, the battery is of simple structure and also the connecting element can be produced in a particularly simple manner. There is only need for a compaction of the connecting element at defined locations, i.e. in the attachment zones respectively provided for attachment onto the electric poles of the battery cells, and these compacted regions are then connected with the electric poles of the battery cell.

According to an advantageous configuration of the invention, the connecting element is compacted in the respective attachment zone by welding the individual wires. The thus fused individual wires represent then a particularly compact solid attachment zone. This is advantageous in terms of realizing a low transition resistance of the connection between the attachment zone and the electric pole of the battery cell.

To melt the individual wires at the margins, resistance welding may be employed in particular to form the compact attachment zone. In this way, a particular intimate bond of the individual wires with one another can be realized with very good electric properties. However, also a pressure welding process may be applicable as well, for example ultrasonic welding, in which the individual wires are welded by friction and pressure. Ultrasonic welding is especially beneficial, when individual wires of the connecting element are involved which are made of aluminum.

It has been shown as further advantageous, when the connecting element is configured substantially cuboid in shape in the respective attachment zone, with a planar contact area of the attachment zone in contact with a planar contact area of a base portion of the electric pole. Such an attachment zone with rectangular cross section enables in terms of dimensions the formation of an especially precisely defined attachment zone which allows realization of a simple and reliable installation of the battery. The complementing planar contact surfaces of the attachment zone and the base portion further provide a particularly good electrically conducting connection between the connecting element and the electric poles of the battery cells.

In the respective attachment zone, the connecting element can have a through opening which receives a substantially pin-shaped component of the respective electric pole. This simplifies positioning of the attachment zones in relation to the electric poles. The through opening may, for example, be formed by making a bore in the attachment zone.

In particular, the connecting element can be connected in the respective attachment zone with the electric pole through threaded engagement. In this way, the contact pressure by which the attachment zone contacts the respective electric pole of the battery cell can be adjusted especially well. Such threaded engagement of the attachment zone with the electric pole is appropriate for example, when a pin-shaped component of the respective electric pole has a screw thread onto which a screw nut can be threadably engaged.

A particularly intimate connection of the connecting element with the electric poles can, however, be implemented when the connecting element is connected by a material joint with the electric pole in the respective attachment zone. The provision of the compacted attachment zones on locales of the connecting element that complement the electric poles enables a particularly precise positioning of the parts to be joined by a material joint. In addition, the connection by material joint enables realization of an especially high and particularly consistently high bonding quality. Connection by material joint may in particular be implemented by a beam welding process, such as laser beam welding, allowing a very high welding rate.

When providing a through opening in the attachment zone for receiving a pin-shaped component of the respective electric pole, realization of a connection by material joint can be especially easy when producing butt welds and/or fillet welds during welding.

In addition or as an alternative, the connecting element can be welded with the electric pole in an overlap zone in which the respective attachment zone contacts a base portion of the electric pole. In this case, welding is performed through the compacted attachment zone into the base portion of the electric pole. In this way, the flat contact of the attachment zone upon the base position can be utilized in a particularly good manner so as to ensure a reliable bond between the connecting element and the electric poles. The flat contact can be ensured during the welding process by a clamping apparatus.

The connecting element may be formed from a fabric band or a litz wire, with a flat litz wire being used in particular. Such fabric tapes or litz wires can be compacted in the designated regions in a particularly simple manner.

The individual wires of the connecting element are made preferably of copper or aluminum to realize a good electrically conducting connection to the electric poles of the battery cells.

In the method according to the invention for manufacturing a battery having at least two battery cells and provided in particular for a vehicle, individual wires of a connecting element having plural individual wires are compacted in a respective attachment zone. At least one electric pole of a first battery cell is connected by the connecting element with an electric pole of at least one further battery cell of the battery. The connecting element is hereby brought into contact in the respective attachment zone with the respective electric pole of the battery cell for electrically connecting the poles with one another. The individual wires are compacted in evenly spaced-apart attachment zones, wherein the distances of the attachment zones correspond to the distances of the electrical poles of the battery cells in the cell assembly of the battery. This direct contacting of the electric poles of the battery cell with the compacted attachment zone of the connecting element enables realization of a particularly simple structure of the battery, and at the same time a beneficial, low transition resistance is established in the area of the connection of the connecting element with the electric poles.

The advantages described for the battery according to the invention and preferred embodiments also apply to the method according to the invention, and vice versa.

The features and feature combinations mentioned above in the description and the features and feature combinations mentioned hereinafter in the figure description and/or shown alone in the figures are applicable not only in the respectively described combination but also in other combinations or taken alone, without departing the scope of the invention.

Further advantages, features and details of the invention become apparent from the claims, the following description of preferred embodiments and from the drawings. It is shown in:

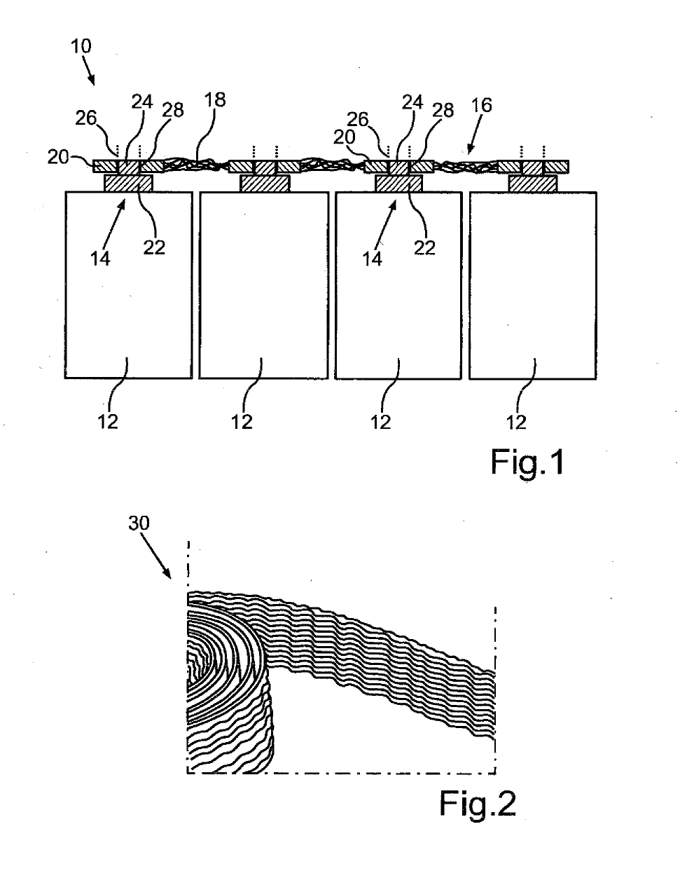

FIG. 1 schematically a battery with a plurality of battery cells, in which the electric poles are connected to one another by a cell connector in the form of a flexible flat litz wire which is compacted in the respective attachment zones onto the electric poles;

FIG. 2 by way of example, a fabric band suitable as starting material for the production of a cell connector, as shown in FIG. 1; and

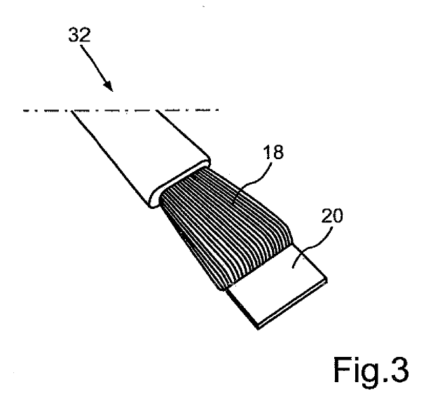

FIG. 3 a round litz wire with attachment zone compacted by welding and intended for attachment thereof to the electric pole of a battery cell according to FIG. 1.

FIG. 1 shows schematically a battery 10, which can be used as traction battery in an electric vehicle or hybrid vehicle. The battery 10 includes a plurality of battery cells 12 which in particular may be formed as a lithium-ion cells. Electric poles 14 of the respective battery cells 12 are electrically interconnected by a connecting element in the form of a flat litz wire 16. The flat litz wire 16 has plural individual wires 18 which due to their flexibility are able to compensate deviations of an actual position of the battery cells 12 from a desired position in all spatial directions.

The individual wires 18 of the flat litz wire 16 are compacted in evenly spaced-apart attachment zones 20, i.e. connected to form a solid unit. The distances correspond hereby to the distances of the electric poles 14 of the battery cells 12 in the cell assembly of the battery 10. Here, the flat litz wire 16 is compacted in the attachment zones 20 by resistance welding, causing a melting at the margins and connection of the individual wires 18 of the flat litz wire 16.

The connection of the flat litz wire 16 with the electric poles 14 of the battery cells 12 is implemented in these attachment zones 20. As a result of the regions provided between the compacted attachment zones 20 with the flexible individual wires 18, both the connecting areas of the attachment zones 20 with the electric poles 14 and the electric poles 14 remain substantially free of mechanical stress even during operation of the battery 10.

The flat litz wire 16 has in the compacted attachment zones 20 properties like those of a solid, rigid conductor bar. Thus, the flat litz wire 16 can be connected with the electric poles 14 in these compacted attachment zones 20 like a solid conductor bar.

The respective electric pole 14 includes here a base 22 and a pin or bolt 24 extending out from the base 22. When threadably engaging the flat litz wire 16 with the electric poles 14, this bolt 24 can be configured as threaded bolt.

The bolt 24 is inserted here in a bore which is formed in the compacted attachment zone 20 of the flat litz wire 16. This insertion of the bolt 24 into the bore provided in the respective attachment zone 20 is followed in the production of the battery 10, shown in FIG. 1, by the connection of the attachment zone 20 with the respective electric pole 14 through welding, in particular laser beam welding. Respective laser beams 26 are indicated schematically in FIG. 1. The laser beam welding results in a material joint of the bolt 24 with the flat litz wire 16 via a circumferential butt weld 28 in the attachment zone 20.

In addition, a planar, flat underside of the attachment zone 20 is in contact with a planar, flat topside of the base 22. In an alternative embodiment, it is also possible to weld in these regions in which the attachment zone 20 and the base 22 overlap through the compacted attachment zone 20 into the base 22 to realize a material joint of the flat litz wire 16 to the electric poles 14 of the battery cells 12.

Instead of the flat litz wire 16, also a fabric band 30, shown by way of example in FIG. 2, may be used as starting material for the production of the connecting element for connecting the electric poles 14. Such a fabric band 30 can—just like the flat litz wire 16—be made especially from copper or aluminum. By welding, in particular resistance welding, this fabric band 30 can be provided with compacted attachment zones 20 at locations that are intended for contacting the electric poles 14, and subsequently, the fabric band 30 is connected with the electric poles 14 in the compacted attachment zones 20. Hereby, the use of beam welding processes has proven promising because the parts to be joined can be positioned in a particularly precise manner.

FIG. 3 shows a round litz wire 32 as alternative starting material for a connecting element for electrically connecting the electric poles 14 of the battery cells 12. The individual wires 18 of such a round litz wire 32 are also compacted in the attachment zone 20.

As can be seen especially well in particular in FIG. 3, the litz wire has an attachment zone 20 which is cuboid in shape, i.e. a rectangular cross section with precise dimensions. Compaction realizes in the attachment zone 20 a planar, uniform surface which can then be brought into contact with the electric pole 14 of the respective battery cell 12 especially well.

The actual connection of the attachment zone 20 with the respective electric pole 14 of the battery cell may be implemented by threaded engagement or, as described above, by welding.

1.-10. (canceled)

11. A battery, comprising:
a plurality of battery cells having each an electric pole provided with a base portion; and
at least one connecting element Shaving plural individual wires which are compacted in evenly spaced-apart locations to define cuboid attachment zones, each said attachment zone having a planar contact area for contacting a planar contact area of the base portion of the electric pole of a one of the battery cells so that the electric poles of the plurality of battery cells are connectable to one another by the connecting element via the attachment zones, wherein a distance between adjacent attachment zones corresponds to a distance between adjacent electric poles of the battery cells.

12. The battery of claim 11, constructed for installation in a vehicle.

13. The battery of claim 11, wherein the connecting element is compacted in the attachment zones by welding the individual wires.

14. The battery of claim 11, wherein the attachment zones of the connecting element have each a through opening for receiving a pin-shaped component of the electric poles.

15. The battery of claim 11, wherein the connecting element is connected in the attachment zones with the electric poles through threaded engagement.

16. The battery of claim 11, wherein the connecting element is connected in the attachment zones with the electric poles by a material joint.

17. The battery of claim 16, wherein the material joint is realized by a beam welding process.

18. The battery of claim 11, wherein the connecting element is welded with the electric pole in an overlap zone in which the attachment zone contacts the base portion of the electric pole.

19. The battery of claim 11, wherein the connecting element is formed from a fabric band or a Utz wire.

20. The battery of claim 19, wherein the litz wire is a flat litz wire.

21. The battery of claim 11, wherein the individual wires of the connecting element are formed from copper or aluminum.

22. A method for manufacturing a battery having a plurality of battery cells, comprising:
compacting plural individual wires of a connecting element at evenly spaced-apart locations to define cuboid attachment zones to thereby form each of the attachment zones with a planar contact area, wherein a distance between adjacent attachment zones corresponds to a distance between adjacent electric poles of the battery cells; and
electrically connecting the electric poles of the battery cells by contacting the planar contact area of the attachment zones with a planar contact area of a base portion of the electric poles of the battery cells.

23. The method of claim 22, wherein the battery is used for installation in a vehicle.
